(19) United States
(12) Patent Application Publication
(10) Pub. No.: US 2009/0006533 A1
(43) Pub. Date: Jan. 1, 2009

(54) SERVER-AIDED APPROACH TO IMPROVE MEDIA NEGOTIATION EFFICIENCY

(75) Inventor: Hui Guo, Santa Clara, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/770,571

(22) Filed: Jun. 28, 2007

(51) Int. Cl. G06F 15/16

(52) U.S. Cl. 709/203

(57) ABSTRACT

A network device, system, and method are directed towards employing a media advisor to determine a media match for media types among computing devices. During a SIP communications, a caller device sends an SIP/SDP invite message to a callee device, which is received by a first proxy server and forwarded to a second proxy server. The second proxy employs the media advisor to perform a media agreement using information about the caller and callee to determine a matching codec for the given media type. The media advisor returns the match information to the second proxy server, which reformats the invite to substitute the provided codec/media information with the match information. The proxy server then forwards the modified invite message to the callee computing device. The callee computing device, confirming the match, responds with an okay type response that is sent to the caller to establish the call session.

### TECHNICAL FIELD

The present invention relates generally to mobile communications and, more particularly, but not exclusively to employing a media advisor to determine a best media match for media types among computing devices to eliminate multiple Session Description Protocol (SDP) exchanges between the computing devices.

### BACKGROUND

Tremendous changes have also been occurring in the wireless communications that influence our everyday lives. For example, the available of third generation/fourth generation, and WiFi (3G/4G/WiFi) high speed wireless access technologies makes it possible to establish Internet Protocol (IP) based peer-to-peer communications for multimedia applications among various mobile devices with the requisite quality of service. Examples of such applications include white board discussions, video conferencing, Push to talk over Cellular (PoC), Voice over IP, real-time content sharing including videos/audios/images, instant messaging, interactive gaming, presence, and the like. One challenge however in satisfying a user experience with these rich media applications among a large variety of different computing devices running over diverse networks is to ensure an end-to-end Quality of Service (QoS).

One architectural framework that has been designed for delivering IP-based services to mobile devices is known as IP Multimedia Subsystem (IMS). IMS was originally designed by the wireless standards body 3rd Generation Partner Project (3GPP) as a standard to support IP-based peer-to-peer multimedia applications running in a heterogeneous network and/or mobile device environment. Many implementations of IMS employ Session Initiation Protocol (SIP) for session management, including, for example, to establish, modify, and terminate media sessions for various applications. A Session Description Protocol (SDP) Offer/Answer model is used in concert with SIP during session establishment to, among other things, guarantee an end-to-end QoS through media negotiation to arrive at a common view of a multimedia session regarding media types and CODECS between computing devices. Use of such protocols, however, may sometimes result in increased network traffic, and inefficiencies. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of a process for a callee proxy server in managing at least a portion of a Session Initiation; and

FIG. 5 illustrates a logical flow diagram generally showing one embodiment of a process for a media advisor in determining a media agreement between caller and callee computing devices;

FIG. 6 illustrates a signal flow diagram generally showing one embodiment of a flow for negotiating a session initiation using the media advisor; and

FIG. 7 shows one embodiment of device media capabilities data useable in determining a media agreement, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “Session Initiation Protocol and “SIP” refer to an application layer control (signaling) protocol for, among other things, creating, modifying, and terminating sessions with one or more computing devices, as described within Request For Comments (RFC) 3261. RFC 3261 is available from the Internet Engineering Task Force (IETF), and is hereby incorporated by reference. SIP, in one embodiment, acts as a carrier for Session Description Protocol (SDP). As used herein the terms “Session Description Protocol” and “SDP” refer to a protocol for describing multimedia sessions, including session announcements, session invitations, and other forms of multimedia session initiation as described within RFC 4566, which is available from the IETF, and which is further hereby incorporated by reference. Moreover, as used herein, the term “codec” refers to any device and/or program configured and arranged to perform encoding and/or decoding on digital data.

As used herein, the terms “text messaging,” or “text message” refer to SMS messaging, as well as a variety of other limited size message protocols, including, but not limited to Multimedia Messaging Service (MMS) message, or an Enhanced Message Service (EMS) message protocols.

Briefly stated the present invention is directed towards employing a media advisor to determine a best media match for media types among computing devices to eliminate multiple Session Description Protocol (SDP) exchanges between the computing devices. In one embodiment, at least one of the computing devices is a mobile computing device. The media advisor is configured to provide a server-aided media negotiation application. During a typical SIP communications, proxy servers may be employed to assist in routing requests. Thus, in one embodiment, each computing device may communicate during an SIP session through one or more proxy servers. A caller computing device may send an SIP/SDP invite message over a network towards a callee computing device. The invite message may include information about codecs and media with which the caller may use during a communication with the identified callee. Moreover, associated with the invite message, or another message, is a device identifier for the callee. The invite message may be intercepted by a first proxy server and redirected to a second proxy server. The second proxy then is configured to employ the media advisor to perform a media agreement. The media advisor employs information about the caller and callee to search a data store and determine whether there is a best match codec for the given media type. If there is a match, the media advisor returns the match information to the second proxy server, which in turn reformats the invite to substitute the provided codec/media information with the match information. The proxy server then forwards the modified invite message to the callee computing device. The callee computing device, confirming the, match, responds with an okay type response that is sent to the caller to establish the call session.

By employing the media advisor, a number of network communication exchanges may be reduced. This is because current configurations of IMS enforce a selection of a single codec per media stream. In IMS, the selection of a single codec per media stream typically requires at least two message exchanges. Use of the media advisor is directed towards reducing the number of message exchanges required to select a single codec per media stream. Thus, use of the media advisor may intelligently influence media negotiations during session establishment, thereby improving session set up efficiency, simplifying media negotiation on computing devices, and further reducing network traffic.

As described herein, use of the media advisor is further directed towards enabling rich media applications easier to launch, and improving user's overall experience. The media advisor may further reduce air traffic and save network resources by cutting media negotiation traffic on the network. Moreover, the media advisor may further reduce complexity in an IMS session establishment. Use of the media advisor may even be extended to mitigate worst case type of scenarios of media policing, where some call session control entities across networks can reject media types or codecs offered in the SDP communications.

### Illustrative Operating Environment

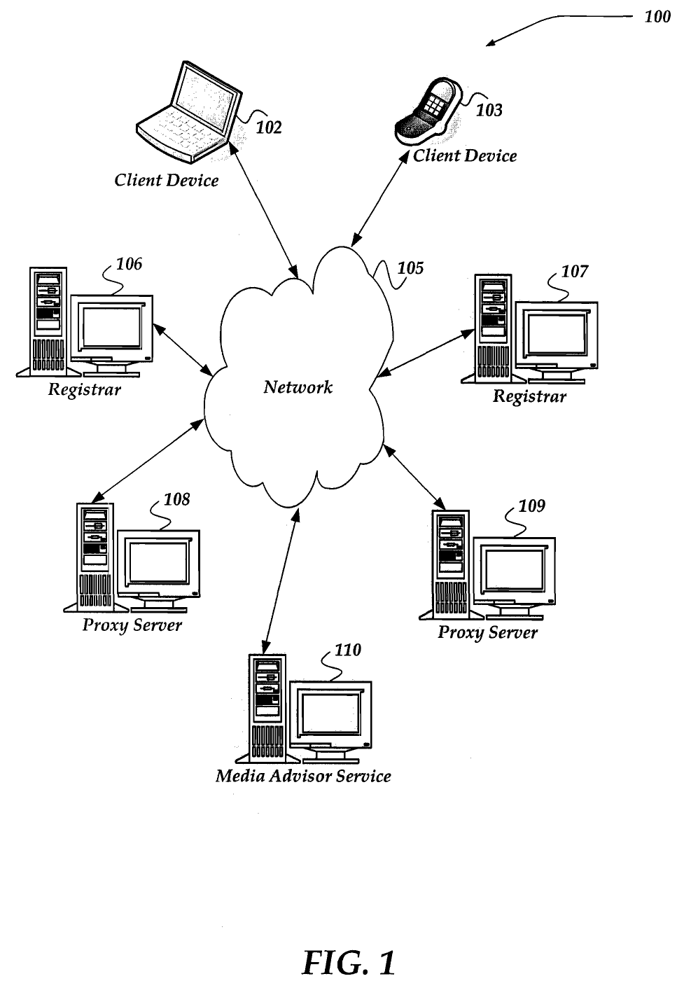

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes client devices 102-103, network 105, registrars 106-107, proxy servers 108-109, and media advisor service 110.

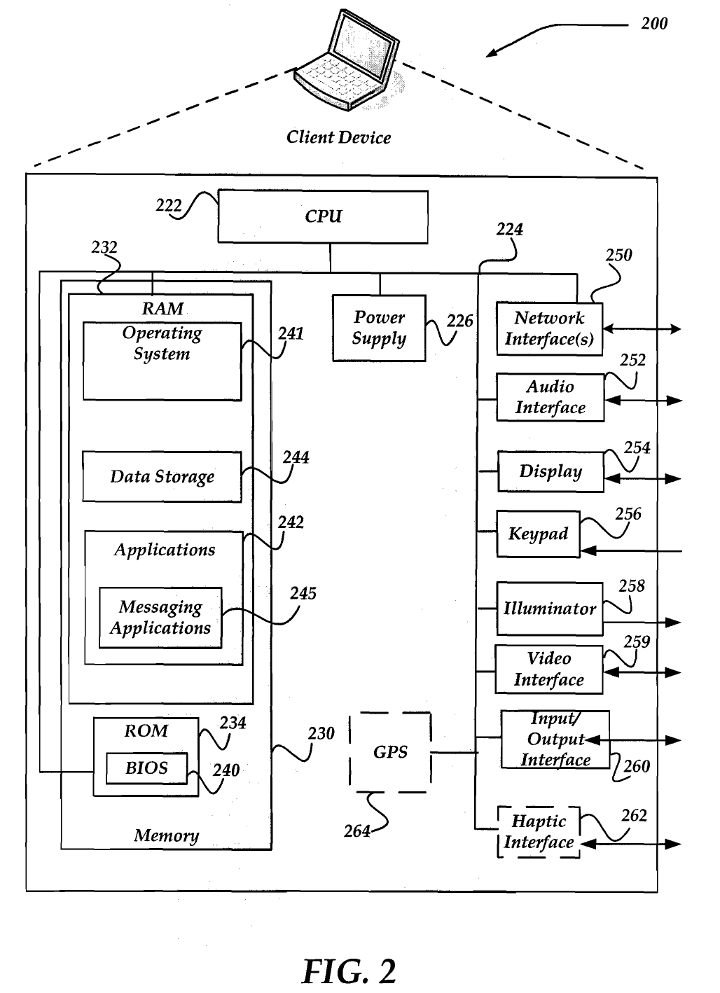

One embodiment of client devices 102-103 is described in more detail below in conjunction with FIG. 2. Generally, client devices 102-103 may include virtually any computing device capable of connecting to another computing device to send and receive information, including web requests for information from a server, providing content, or the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any network device. Similarly, client devices 102-103 may be any device that is capable of connecting using a wired or wireless communication medium such as a PDA, POCKET PC, wearable computer, and any other device that is equipped to communicate over a wired and/or wireless communication medium.

Client devices 102-103 may also include a client application that may be configured to provide information that identifies itself, including a type, capability, name, and the like. Client devices 102-103 may identify themselves through any of a variety of mechanisms, including a phone number, Mobile Identification Number (MIN), an electronic serial number (ESN), or a network address, such as an Internet Protocol (IP) address, or virtually any other device identifier. In one embodiment, client devices 102-103 may be configured to provide such network address identifier in a message, or the like, sent over network 105 to another computing device.

Client devices 102-103 may further include a client application that is configured to manage various actions. For example, client devices 102-103 may include a web browser application that is configured to enable an end-user to interact with other devices and/or applications over network 105. For example, client devices 102-103 may enable use of the web browser to access content, web pages, or the like, from another computing device, such as content servers 107-109, or the like.

In addition, client devices 102-103 may employ a variety of other client applications to communicate with other devices over network 105, including, but not limited to Voice Over Internet Protocol (VOIP), Instant Messaging (IM), Short Message Service (SMS), Multimedia Message Service (MMS), email, or the like. Moreover, client devices 102-103 may include a variety of applications configured and/or arranged to enable a user to initiate, accept, and otherwise participate in a multimedia communications session over network 105. Thus, client devices 102-103 may employ a variety of mechanisms and/or protocols to establish and maintain network sessions with another computing device, including, but not limited to IMS, SIP, SDP, or the like.

Network 105 is configured to couple one computing device with another computing device to enable them to communication information. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link.

Network 105 may further employ a plurality of access technologies including 2nd (2G), 3rd (3G), 4th (4G) generation radio access for cellular systems, WLAN, Wireless Router (WR) mesh, or the like. Access technologies such as 2G, 3G, 4G, and future access networks may enable wide area coverage for mobile devices, such as client devices 102-103 with various degrees of mobility. For example, network 105 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, or the like. In essence, network 105 may include virtually any wireless communication mechanism by which information may travel between client devices 102-103 and another computing device, network, or the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Registrars 106-107 include virtually any network device that may be configured and arranged to bind a user name to a contact address for use in at least SIP activities. As illustrated, there are two registrars, one for each of the client devices. Thus, for example, registrar 106 may be associated with client device 102, to enable client device 102 to perform registration, while registrar 107 may be employed by client device 103 to perform registrations. It should be understood, however, the invention is not so limited. Thus, for example, a single registrar may be employed to enable both client devices to perform registration, without departing from the scope of the invention.

During registration, a user device relationship may be established. Such registration is directed towards binding a user's identity, such as a name, alias, or the like, with a contact address. The registration process may also be extended to include a user identity with a device identifier. In any event, in one embodiment, this registration may then be employed within IMS. In one embodiment, an IMS register request may be issued by a client device, which has knowledge of its make, model, capabilities, or other device information. Moreover, an IMS register request may be expanded to include this device information during information and a user identity to device relationship may then be established and stored by the registrar.

Devices that may operate as registrars 106-107 include personal computers desktop computers, multiprocessor systems, microprocessor-based or programmable consumer electronics, network PCs, servers, network appliances, or the like.

Proxy servers 108-109 include virtually any network device that may be configured and arranged to act on behalf of another computing device, such as client devices 102-103, or the like, to forward at least SIP/SDP requests and responses to another computing device. Thus, proxy servers 108-109 may assist in routing requests for a user's current location, authenticate and/or authorize users for services, implement provider call-routing policies, and/or provide a variety of other communication features to client devices 102-103. Although illustrated as outside of network 105, it should be apparent that proxy servers 108-109 may also be included as components within network 105.

In one embodiment, proxy server 108 may be associated with one of the illustrated client devices, such as client device 102, while proxy server 109 may be associated with client device 103. Thus, during a SIP communication, client device 102, may send SIP requests and receive SIP responses through proxy server 108. Similarly, client device 103 may send SIP requests and receive SIP responses through proxy server 109. However, the invention is not so limited, as this merely represents one possible configuration. Thus, in another embodiment, a single proxy server may be employed by both client devices. Moreover, the relationship between client devices and proxy servers may be switched, without departing from the scope of the invention. Furthermore, proxy servers 108-109 may also reside within a single network device. Devices that may operate as proxy servers 108-109 include personal computers desktop computers, multiprocessor systems, microprocessor-based or programmable consumer electronics, network PCs, servers, network appliances, or the like.

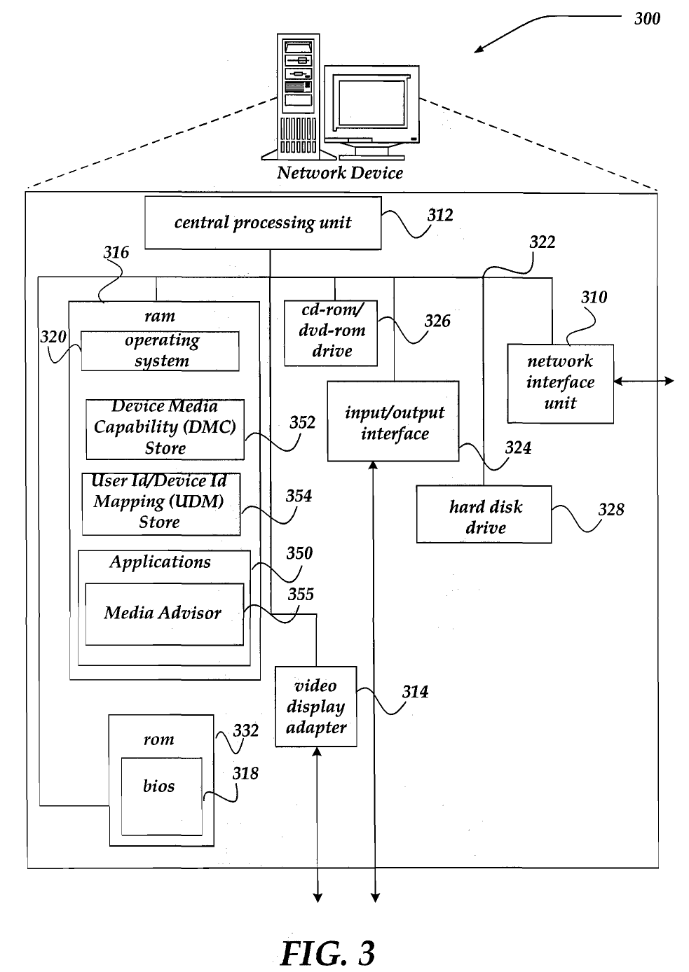

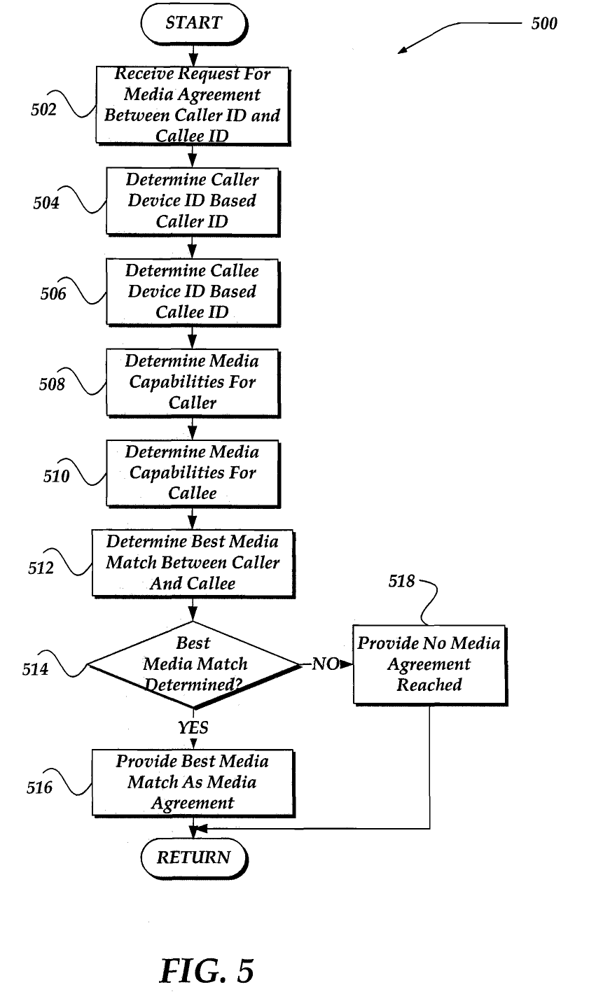

Media Advisor service 110 is configured and arranged to manage media compatibility requests by proxy servers 108-109, and provides a media agreement to the requesting proxy server. Although illustrated within a distinct network device, the invention is not so limited. Media advisor server 110 may also reside within one or both of proxy servers 108-109, and/or registrars 106-107. Moreover, components of media advisor service 110 may be distributed across a plurality of network devices, without departing from the scope of the invention. However, one embodiment of media advisor service 110 within a single network device is described in more detail below in conjunction with FIG. 3. In addition, one embodiment of a process useable by media advisor service 110 is described in more detail below in conjunction with FIG. 5.

Devices that may operate as media advisor service 110 include personal computers desktop computers, multiprocessor systems, microprocessor-based or programmable consumer electronics, network PCs, servers, network appliances, or the like.

In one embodiment, a peer-to-peer communication established between a caller device and a callee device can be extended to a group communication among more than two devices. Thus, the invention is not limited to a communication between two devices.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, client devices 102-103 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), BitTorrent file-sharing technology, SIP/SDP/Real-time Transport Protocol (RTP), Secure RTP, IMS, or any of a variety of other wireless, and/or wired communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, the Symbian® operating system, OSE real-time operating system, or any of a variety of other operating systems. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. In one embodiment, the information may be provided using a user agent application. Moreover, data storage 244 may also be employed to store multimedia information, including address lists, contact lists, personal preferences, or the like. Data storage 244 may also include device identifier information, user identifier information, or the like. In one embodiment, user identifier information, or the like, may be provided to another computing device, based upon a request, a communication with the other computing device, or the like. At least a portion of the information may also be stored on a disk drive or other storage medium (not shown) within client device 200.

Applications 242 may include computer executable instructions which, when executed by client device 200, enable a variety of operations. Examples of application programs include calendars, browsers, email clients, contact managers, task managers, transcoders, database programs, word processing programs, security applications, spreadsheet programs, games, search programs, user profile agents, and so forth. Applications 242 may further include messaging applications 245 that is arranged to transmit, receive, and/or otherwise process messages including SMS, MMS, IM, IMS, and/or other message protocols, including message protocols useable for communicating multimedia information. Thus, messaging applications 245 may include one or more applications configured and arranged to enable white board discussions, video conferencing, Push to talk over Cellular (PoC), Voice over IP, real-time content sharing including videos/audios/images, text messaging, interactive gaming, presence, or the like. Messaging applications 245 are not limited to these examples, however, and other messaging applications may also be included.

Applications 242 may also include one or more user agent applications that may be configured and arranged to provide client device capabilities to another device. Such client device capabilities may be provided using any of a variety of formats, structures, or the like. However, in one embodiment, the client device capabilities may be provided based on a definition by a User Agent Profile Specification such as is available from the Wireless Application Protocol Forum, Ltd. Another example of an information source for use in determining the client device capabilities includes Composite Capability/Preference Profiles (CC/PP), defined by the World Wide Web Consortium. Further examples of profiles describing client device capabilities that may be employed include a mobile information device profile (MIDP), a wireless universal resource file (WURFL), and the like. In any event, user agent profiles or other similar profiles generally include attributes of a mobile device, such as a screen size, a screen resolution, a memory size, codec capabilities, or the like. Moreover, such device capabilities may be provided to another computing device upon request, or placed within a message header, or the like.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, a server useable for implementing Media Advisor Service 110 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Mass memory may also include device media capability store (DMC) 352, and user Id/Device ID Mapping store (UDM) 354. Applications 350 may also include media advisor 355.

DMC 352 is configured and arranged to store and otherwise manage information about a computing device's capabilities. Such device capabilities include, but are not limited to screen size, a screen resolution, a memory size, codec capabilities, media types, and the like. In one embodiment, such device capability information may be obtained from a computing device.

However, the invention is not so limited, and the information may be obtained from a variety of other sources, including, for example, a registrar, a device vendor, a third party, or the like. DMC 352 may also use any of a variety of formats, structures, databases, spreadsheets, tables, folders, applications, scripts, or the like to store and manage the device capability information.

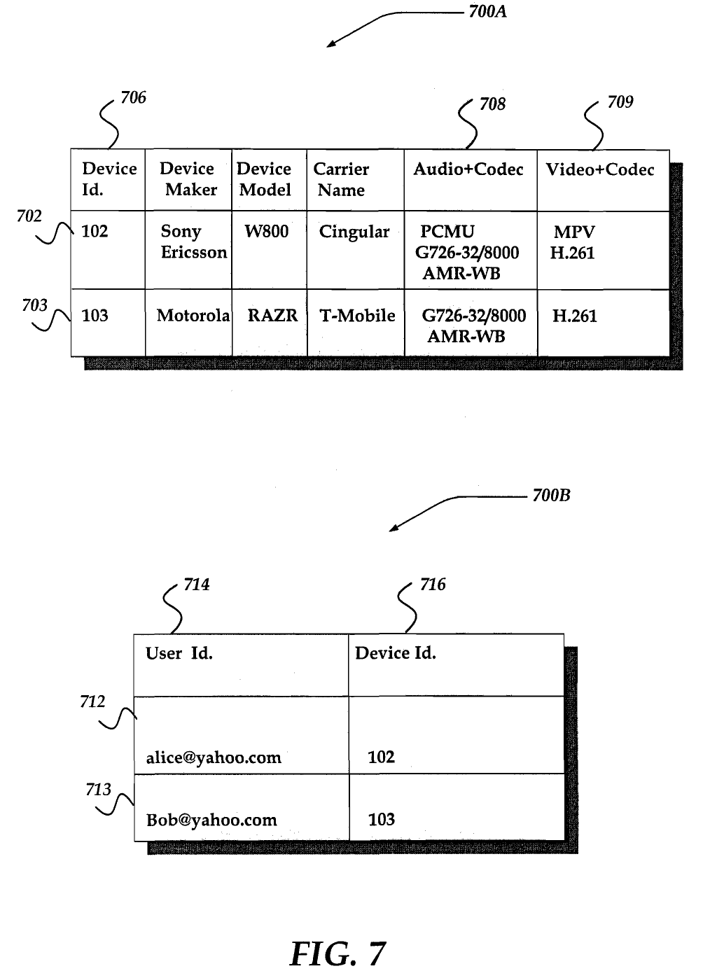

One example embodiment of a device capability table 700A useable within DMC 352 is illustrated in FIG. 7. As shown, each entry 702-703 for a client device, may include, but is not limited to a device identifier (Id.) 706, a device maker, device model, carrier name, as well as corresponding media capabilities 708-709. Media capabilities 708-709 may represent the supported media types and associated codecs. Thus, as shown, for entry 702, client device 102 supports three different audio formats (media capabilities 708) of PCMU, G726, and AMR-WB, and two different video formats (media capabilities 709) of MPV and H.261. Also shown, for entry 703, client device 103 (device Id. 706) supports two different audio formats (media capabilities 708) of G726, and AMR-WB, and one video formats (media capabilities 709) of H.261. It should be noted, that DMC 352 (and device capability table 700A) may include more, or less items than illustrated. Thus, device capability table 700A as shown is not intended to be limiting in any manner.

UDM 354 is configured and arranged to store and otherwise manage user identifier to device identifier mappings. Currently, such mapping is employed to support implementations of SIP implementations that provide user identifiers in SIP messages instead of device identifier information. UDM 354 may use any of a variety of formats, structures, databases, spreadsheets, tables, folders, applications, scripts, or the like to store and manage the mapping information. One embodiment of a mapping table 700B useable within UDM 354 is illustrated in FIG. 7. However, it should be noted, the mapping table 700B may include more, or less items that illustrated. Thus, mapping table 700B should not be interpreted as limiting the scope of the invention. As shown in FIG. 7, mapping table 700B includes entries 712-713, each of which include user identifier (Id.) 714 information, and device identifier (Id.) 716 information.

Media advisor 355 may be configured and arranged to receive a request to negotiate a media agreement between computing devices. Media advisor 355 may, in one embodiment, receive a caller's user Id., and a callee's user Id, with or in addition to the request. Media advisor 355 may then employ mapping table 700B to locate corresponding device Ids. The corresponding device Ids may then be employed by media advisor 355 to search device capability table 700A to locate a device's corresponding media capabilities. Media advisor 355 may employ this information to determine whether there is a matching codec per media type. In one embodiment, the matching determination may be based on satisfying any IMS conditions, criteria, or the like. If a match is not determined, media advisor 355 may, in one embodiment, provide information indicating that a match is not determined. For example, media advisor 355 might provide an empty message, such as content-type: application/sdp being null, or the like. Media advisor 355 may employ a process such as described below in conjunction with FIG. 5 to perform at least some of its actions.

While network device 300 illustrates DMC 352, UDM 354, and media advisor 355 all residing in a single network device, the invention is not so limited. For example, in one embodiment, such components may be distributed across a plurality of different network devices.

### Generalized Operation

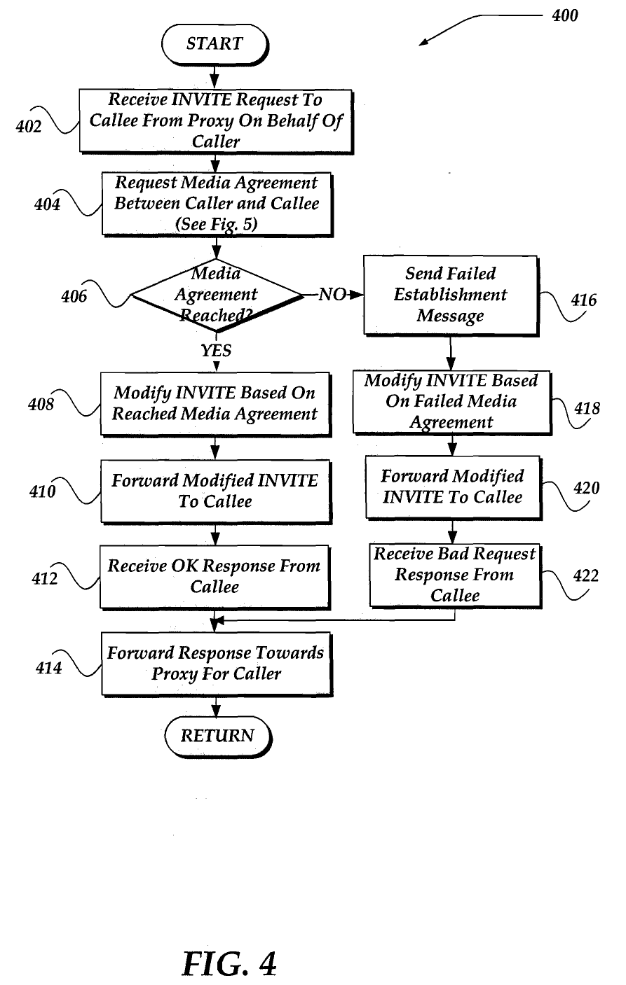

The operation of certain aspects of the invention will now be described with respect to FIG. 4. FIG. 4 illustrates a logical flow diagram generally showing one embodiment of a process for a callee proxy server in managing at least a portion of a Session Initiation. Process 400 may be employed by one or more proxy servers, such as illustrated in FIG. 1 (see proxy servers 108-109).

Typically, a user of a client device may register their client device with a registrar, where their user identifier may then be associated with a device identifier. In one embodiment, the registrar may be different for each user and/or client device. In one embodiment, the registrars may then provide the user identifier/device identifier information to a media advisor service, or otherwise make such information available to the media advisor service.

Process 400 of FIG. 4 begins, after a start block, at block 402, when a user (a caller) selects to launch an IMS call to another user (the callee). The proxy server associated with the caller receives an INVITE request that may include a first SDP offer for a call to the caller. The caller's proxy server then forwards the INVITE request to a proxy server associated with the callee. Within or otherwise associated with the INVITE request may be the caller's user id, and the callee's user id.

Processing flows next to block 404, which is described in more detail below in conjunction with FIG. 5. Briefly, however, at block 404 the callee's proxy server consults with a media advisor to request media agreement between the caller and callee. Processing then flows to decision block 406 where a determination is made whether a media agreement is reached for the caller/callee. If no media agreement was determined by the media advisor, processing flows to block 416; otherwise, processing continues to block 408.

At block 408, the callee's proxy server may then modify the received INVITE based on the reached media agreement. In one embodiment, the received SDP offer within the INVITE might be modified by incorporating the media agreement into the INVITE request. The modified SDP then includes one codec per media type per the IMS request.

Processing continues next to block 410, where the modified INVITE is forwarded to the callee computing device. Because the INVITE includes a codec per media type that is compatible with the callee's computing device, the callee shares the same view as the caller. Thus, the callee responds to the INVITE request by sending an okay response with the first SDP answer with the agreed media types and codec. Thus, proceeding to block 412, an okay response is received. In one embodiment, the okay response is known as a 200/OK type response.

Processing continues to block 414, where the response is then forwarded to the caller's proxy server, which in turn forwards the response to the caller. Where the response is an okay response type, the caller may then send an Acknowledgement (ACK) message to the callee. A media session may then be established between the caller and callee. Moreover, media resources are reserved on both the caller and callee computing devices directed towards a defined QoS. Once the users of the devices terminate the media session, a BYE request may be sent by one of the computing devices. The other computing device may respond to the BYE request by sending a 200/OK response to terminate/close the media session. Thus, process 400 may then return to a calling process to perform other actions.

However, if at decision block 406, it is determined that no media agreement is reached, processing flows to block 416. At block 416, the media advisor may send a message indicating that no media agreement is reached. Thus, processing moves to block 418, where the callee's proxy server may then forward a problematic INVITE message, by, in one embodiment, modifying the INVITE message such that no SDP body is included for the media agreement. However, the invention is not limited to this mechanism, and others may also be employed. In any event, processing flows to block 420, where the modified INVITE message is forwarded to the callee. When the callee receives this message, the callee may interpret the null SDP body as invalid. In which instance, in one embodiment, the callee may respond with a 400 (Bad Request) response code. At block 422, the bad request response is received by the callee's proxy server. Processing continues then to block 414, where the proxy server may then forward the response on towards the caller, where no media session might be established. Processing may then return to a calling process to perform other actions.

It should be noted, that while the above describes distinct proxy servers, the invention is not so limited, and a single proxy server may also be employed, without departing from the scope of the invention.

FIG. 5 illustrates a logical flow diagram generally showing one embodiment of a process for a media advisor in determining a media agreement between caller and callee computing devices. As such, process 500 of FIG. 5 may represent one possible embodiment of a process useable within block 404 of FIG. 4, above. Moreover, process 500 may be employed by media advisor service 110 of FIG. 1.

Process 500 begins, after a start block, at block 502, where a request is received for a media agreement between a provided caller (user) id and a callee (user) id. Processing flows to block 504, where a caller user identifier is used to determine the caller's device identifier. Processing continues next to block 506, where the callee's identifier is used to determine the callee's device identifier. Such determinations may employ, in one embodiment, stores, and/or tables, or the like, such as described above.

Processing proceeds next to block 508, where, using the caller's device identifier, media capabilities for the caller's device is determined. Proceeding to block 510, the callee's device identifier may be employed to determine media capabilities for the callee's device. Such determinations may employ, in one embodiment, stores, and/or tables, or the like, such as described above.

Processing continues next to block 512, where a best media match per media type is determined based on the media capabilities identified for the caller and callee. In one embodiment, a table such as that described above may be employed to determine media matches for the media types. In one embodiment, a best media match might be determined based on a variety of factors. For example, in one embodiment, if a single codec is common between the caller and callee for a media type, then that single codec is determined to be the best media match for the media type. However, where there might be more than one codec that is common between the caller and callee for the media type, than further analysis might be performed. For example, in one embodiment, a codec having a highest compression ratio might be selected from the common codecs. In another embodiment, a codec might be selected from the common codecs based on the codec consuming the least compute resources, or is the fastest codec, or any of a variety of other defined criteria. In one embodiment, the defined criteria may be associated with a characteristic of the matching codecs. In another embodiment, the defined criteria may also be associated with a network characteristic, such as a network characteristic between the caller and the callee, including a congestion metric, a bandwidth metric, a network type, or the like. However, the invention is not limited to these criteria, and virtually any criteria may be used to determine a ‘best’ single codec. Thus, where multiple codecs are determined to be in common for the media type, a single codec is still selected. By selecting a single codec for the media type, multiple SDP exchanges between the caller and callee can be minimized.

It should be noted that a variety of optimizations can be introduced to blocks 508, 510, 512, and/or 514. For instance, additional blocks can be introduced to speed up the media agreement determination. For example, one block may be inserted prior to block 508 to store a match result using a caller device id and a callee device id and another block may be inserted to lookup a match result to speed media match operations. For example, in one embodiment, the determined best media match between the caller and the callee may be stored for later access. Then, if it is determined that the caller and callee (based on device ids, user ids, or the like) are requesting another media session negotiation, a lookup may be performed to locate the earlier determined best media match. Thus, in one embodiment, blocks 508, 510, 512, and 514 may be bypassed on repeat requests between the same caller/callee.

Processing moves next to decision block 514 where a determination is made whether a media match is identified. No media match might be identified, for example, where the caller's device and callee's device as identified in the data store being evaluated does not include matches on codes. Thus, if no media match is identified, processing flows to block 518; otherwise, processing moves to block 516.

At block 516, the determined best media matches are provided to the requestor as a media agreement being reached. Processing then returns to a calling process to perform other actions.

At block 518, however, where no media match is determined, such lack of a match may indicate no media agreement is reached. This situation may also be so provided to the requester. Processing then returns to a calling process to perform other actions. It should be noted, that a media match may be determined for one media type, but not another media type. Thus, for example, an audio media type might be identified, while a video media type match might not be identified, or vice versa, or so forth. Thus, process 500 may be configured to enable both types of results to be returned to the requestor.

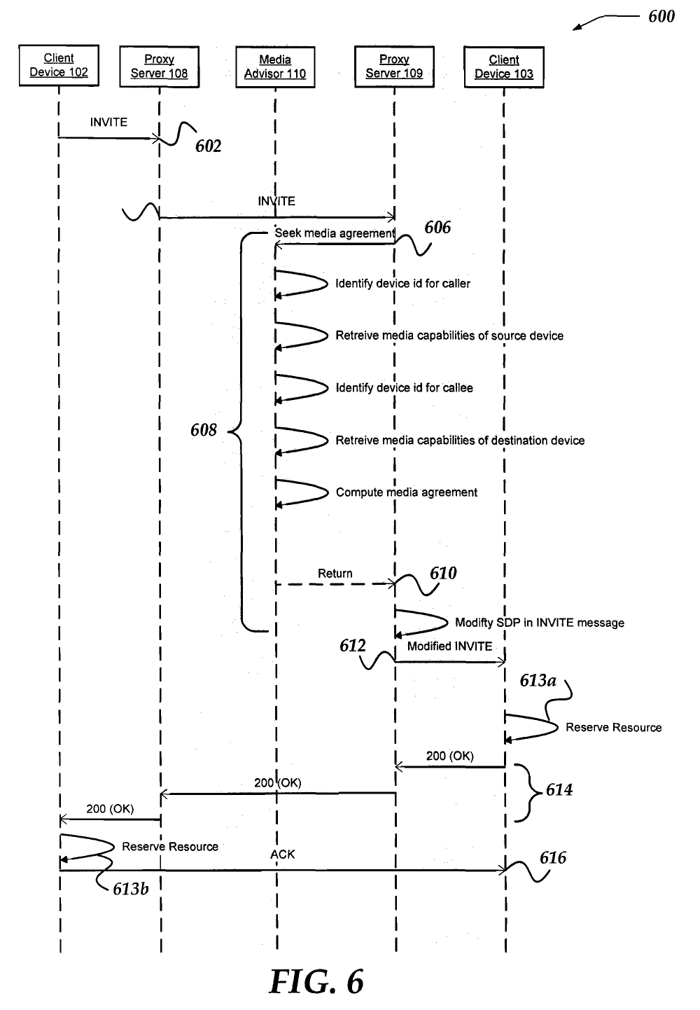

FIG. 6 illustrates a signal flow diagram generally showing one embodiment of a flow for negotiating a session initiation using the media advisor. Flow 600 of FIG. 6 provides an overview of signal flows between various components within one embodiment of an IMS SIP initiation. Flow 600 may include many more or less flows than those shown. The flows shown, however, are sufficient to disclose an illustrative embodiment for practicing the invention. For example, flow 600 does not illustrate the “no media match” situation described above, so as to simplify the flow. However, it should be clear that such flows may readily be included, as they have been described above.

Thus, as shown, flow 600 includes flows between client device 102 (herein shown as the caller), proxy server 108, media advisor 110, proxy server 109, and client device 103 (herein shown as the callee). Time may be considered to flow downwards on the figure from the illustrated components.

As illustrated, client device 102 may send the invite message 602 to proxy server 108. Proxy server 108 may in turn forward the invite message to proxy server 109. Proxy server 109 may then seek a media agreement by sending a request signal 606 to media advisor 110. Through a series of actions 608, as described above, media advisor 110 may determine a media agreement, and provide a return signal 610 to proxy server 109 with a media agreement (or indicating no media agreement was reached). Proxy server 109 may then modify the SDP in the invite message and forward the modified message 612 to client device 103.

In the situation where there is a media agreement, client device 103 may then return a 200/OK response signal 614 that is forwarded onwards to client device 102. Client device 102 then responds with an ACK signal 616.

It is noted also, that resource reservation 613a for client device 103 may be completed before client device 103 sends 200 (OK) response. Likewise, resource reservation 613b for client device 102 may be completed before client device sends ACK response. Moreover, in the situation where there is no media agreement (not illustrated in flow 600) signal 614 may be replaced with a 400/Bad Request signal instead.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system for managing multimedia communications over a network, comprising:
a caller device being configured and arranged to employ an Internet Protocol Multimedia Subsystem (IMS), and to perform actions including:
sending a request to initiate a media session using IMS; and
a media advisor that is interposed between the caller device and a callee device, and is configured to perform actions, including:
determining a caller media capability for the caller device;
determining a callee media capability for the callee device; and
if a match capability is identified between the caller media capability and callee media capability for a media type, providing a single match capability for the media type that is employable by the callee device to enable acceptance of the request for the media session.

2. The system of claim 1, wherein sending the request further comprises sending a Session Initiation Protocol (SIP) INVITE request with a first Session Description Protocol (SDP) offer, and further sending a user identifier associated with the caller device.

3. The system of claim 1, wherein the media advisor is configured to perform actions, further including:
receiving a request to perform a media capability negotiation to determine a media capability match, from a proxy server device associated with the callee device.

4. The system of claim 1, wherein the media advisor is configured to perform actions, further including:
receiving a user identifier associated with the caller device;
receiving a user identifier associated with the callee device;
employing the user identifier associated with the caller device to determine a caller device identifier;
employing the user identifier associated with the callee device to determine a callee device identifier; and
employing the caller device identifier and the callee device identifier to identify the corresponding caller media capability and callee media capability.

5. The system of claim 1, wherein the media advisor is configured to perform actions, further including:
if a match capability is not identified between the caller media capability and callee media capability for a media type, providing an indication of a media disagreement, wherein the media disagreement results in an empty SDP sent to the callee to indicate the media disagreement.

6. A network device arranged to manage a multimedia communications between a caller mobile device and a callee mobile device, comprising:
a transceiver to send and receive data over a network; and
a media advisor component that is operative to perform actions, comprising:
receiving a request for a media agreement between the caller mobile device and the callee mobile device;
determining a caller device identifier and a callee device identifier;
determining a caller device media capability based on the caller device identifier for a media type;
determining a callee device media capability based on the callee device identifier for the media type; and
if a media capability match exists between the caller device media capability and the callee device media capability for the media type, providing a single media capability for the media type, wherein the single media capability is useable within a Session Description Protocol (SDP) message to enable the multimedia communication between the caller mobile device and the callee mobile device.

7. The network device of claim 6, wherein the caller mobile device initially provides a plurality of media capabilities for the media type, wherein the media capabilities are associated with a plurality of different codecs useable for the media type by the caller mobile device.

8. The network device of claim 6, wherein employing the media advisor component enables a reduction of a number of SDP exchanges between the caller mobile device and the callee mobile device.

9. The network device of claim 6, wherein media advisor component is operative to perform actions, further comprising:
if a media capability match exists between the caller device media capability and the callee device media capability for the media type, storing the media capability match such that if the same caller mobile device and callee mobile device seek to initiate another multimedia communications session, the stored media capability match may be used.

10. The network device of claim 6, wherein:
a caller proxy server is configured to receive an invite message from the caller mobile device to initiate the multimedia communications with the callee mobile device, and to forward the invite message to a callee proxy server; and
wherein the callee proxy server is configured to perform actions, including:
sending the request for the media agreement to the network device;
receiving the single media capability for the media type;
modifying the invite message within the single media capability for the media type; and
forwarding the modified invite message towards the callee mobile device.

11. A processor readable storage medium that includes data and instructions, wherein the execution of the instructions on a computing device that is interposed between a caller device and a callee device provides for managing multimedia communications over a network by enabling actions, comprising:
receiving an invite request from the caller device for a multimedia communications session to be established between the caller device and the callee device;
requesting a media agreement to be determined between the caller device and the callee device, wherein the media agreement is determined based on identification of a single codec for a media type for which the caller device and the callee device are configured to be able to employ within the multimedia communications;
if a single codec is determined for the media type, modifying the invite request with information associated with the single codec for the media type; and
forwarding the modified invite request to the callee device, such that a multimedia communications session is established using the single codec.

12. The processor readable storage medium of claim 11, wherein the actions, further comprising:
if a single codec is undetermined for the media type, modifying the invite request with information indicating that a media agreement is un-reached.

13. The processor readable storage medium of claim 11, wherein the invite request from the caller device further identifies a plurality of codecs for the media type that are useable by the caller device.

14. The processor readable storage medium of claim 11, wherein the media agreement is determined, further comprises:
determining a device identifier for the caller device;
determining a device identifier for the callee device;
employing the device identifiers to determine media capabilities of the caller device and the callee device; and
determining if a single codec match exists for the media type between the media capabilities of the caller device and the callee device.

15. The processor readable storage medium of claim 11, wherein the media agreement is determined, further comprises:
if multiple codecs are determined to match for the media type between the caller device and the callee device, selecting the single codec based on a defined criteria, wherein the defined criteria is based, at least in part, on a characteristic of the codec.

16. The processor readable storage medium of claim 11, wherein the invite request is associated with a Session Initiation Protocol (SIP) message and includes a Session Description Protocol (SDP) offer.

17. A method for managing a computing device to manage a multimedia session over a network, comprising:
sending, from a caller device, an invite for the multimedia session towards a callee device;
receiving, at a proxy service, the invite;
sending, by the proxy service, a request for a media agreement between the caller device and the callee device;
determining, by a media advisor, the media agreement, in part, based on if a single codec match exists for a media type useable by the caller device and the callee device based on defined media capabilities of the caller device and callee device for the media type;
providing the media agreement to the proxy service, wherein the media agreement indicates the single codec for the media type that is useable by both the caller device and the callee device;
modifying the invite based on the media agreement; and
forwarding the modified invite to the callee device, such that the callee device and caller device can establish the multimedia session and employ the single codec for the media type.

18. The method of claim 17, wherein the invite from the caller device includes a plurality of codecs useable by the caller device for the media type.

19. The method of claim 17, wherein the invite from the caller device further comprises a Session Description Protocol (SDP) offer and wherein modifying the invite further comprises modifying the SDP offer in the invite.

20. The method of claim 17, further comprising:
if a single codec for the media type is unavailable, modifying the invite with an undefined codec within a Session Description Protocol (SDP) offer, and
forwarding the modified invite to the callee device such that the multimedia session fails to be established between the callee device and caller device based on the lack of media agreement.
